(19) United States
(12) Patent Application Publication
(10) Pub. No.: US 2012/0222426 A1
(43) Pub. Date: Sep. 6, 2012

(54) INTEGRATED GAS TURBINE, SAGD BOILER AND CARBON CAPTURE

(75) Inventor: Scott Macadam, Calgary (CA)

(73) Assignee: CONOCOPHILLIPS COMPANY, Houston, TX (US)

(21) Appl. No.: 13/404,133

(22) Filed: Feb. 24, 2012

Related U.S. Application Data
(60) Provisional application No. 61/449,441, filed on Mar. 4, 2011.

(51) Int. Cl. F02C 3/34

(52) U.S. Cl. 60/783; 60/39.5

(57) ABSTRACT

An integrated power generation system for reducing carbon dioxide emissions is provided. The integrated system comprises a gas turbine having an air inlet, a fuel inlet and an exhaust gas outlet; a steam-assisted gravity drainage (SAGD) boiler having an inlet connected to the exhaust gas outlet of the gas turbine, a fuel inlet, an optional air inlet, and a flue gas outlet; and a carbon dioxide capture system connected to the flue gas outlet of the SAGD boiler. A method for capturing the carbon dioxide exhausted from a gas turbine and a SAGD boiler is also provided.

### CROSS-REFERENCE TO RELATED APPLICATIONS

This application is a non-provisional application which claims the benefit of and priority to U.S. Provisional Application Ser. No. 61/449,441 filed Mar. 4, 2011, entitled “Integrated Gas Turbine, SAGD Boiler and Carbon Capture,” which is hereby incorporated by reference in its entirety.

### FIELD OF THE INVENTION

The invention relates to more efficient methods of generating power that are also less polluting.

### BACKGROUND OF THE INVENTION

With the emerging awareness of global warming and greenhouse gases, carbon capturing becomes an important consideration, especially in the power generation industry. Various carbon capture processes are being investigated for fossil-fuel fired boilers that produce steam for Steam Assisted Gravity Drainage (SAGD) operations. Many of these carbon capture technologies require significant levels of electricity, the generation of which results in additional CO₂ emissions, which increases the specific CO2 emissions rate.

Specific CO₂ emissions rate is defined as:

Specific CO₂ emissions rate=[CO₂ emittedₒₙ₋ₛᵢₜₑ+CO₂ emitted_{off-site}]/[bitumen produced]

The emitted CO₂ includes direct emissions from SAGD operations as well as indirect CO₂ emissions from electricity used by the operations. The off-site CO₂ emissions may be reduced by generating the electricity at another location with renewable power, such as wind, solar or biomass, in a nuclear power plant, or in a fossil fuel-fired power plant with carbon capture and storage; and transmitting the “low CO₂” power to the SAGD facility. However, this presents operational and logistical challenges.

Cogeneration of additional electricity has also been investigated at SAGD facilities as a means of reducing the CO₂ footprint. In SAGD cogeneration plants, electricity is generated in a gas turbine, and hot turbine exhaust gas (TEG) enters a heat recovery steam generator (HRSG) to produce steam for SAGD operations. The HRSG is often supplemented with duct burner firing. This process has two drawbacks: (1) the steam generation efficiency of the HRSG is low due to the high excess air levels (typically 100%), and (2) CO₂ capture from the cogeneration plant is not practical due to the low CO₂ and high O₂ levels in the HRSG flue gas. The integrated GT-Boiler approach has not yet been used in SAGD boilers, largely because SAGD boiler burners have not been developed for TEG operation.

Carbon capture systems, as used in the fossil-fuel burning power industry, refers to systems that removes carbon dioxide from a power station's flue gas, typically through separation from flue gas, followed by compression, transportation and storage at suitable locations. It is generally more difficult to capture the carbon dioxide in the exhaust gas from a gas turbine, because of the relatively low CO₂ content and high oxygen content in the exhaust gas.

U.S. Pat. No. 6,200,128 describes a process in which oxygen is added to the exhaust of a gas turbine, and the O₂-enriched stream is used as oxidant in a boiler. The patent refers to the integrated turbine-boiler process as “hot windbox repowering” and states that it has been considered as a method of increasing the power output and efficiency of power plants. However, by requiring an oxidant source having oxygen content higher than 21% by volume, additional cost must be incurred to provide that oxidant source because pure oxygen is required from an air separation unit. The oxygen-enriched air requirement is an important distinction between '128 and this invention. The drawback of the '128 process is the significant capital and operating cost associated with the air separation unit that produces the oxygen. Furthermore, this method does not provide any carbon capture system to improve the CO₂ avoidance, and therefore that system actually produces more CO₂, and thus is less desirable.

### SUMMARY OF THE INVENTION

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The following abbreviations are used herein:

| | |
|---|---|
| BPD | Barrels per day |
| CAPEX | Capital Expenses |
| DSG | Direct Steam Generator |
| GT | Gas Turbine |
| HRSG | Heat Recovery Steam Generation |
| NGCC | Natural Gas Combined Cycle |
| LHV | Lower Heating Value |
| SAGD | Steam Assisted Gravity Drainage |
| TEG | Turbine Exhaust Gas |

The present invention relates to a cogeneration method that enables high-efficiency generation of electricity at a SAGD facility with CO₂ capture, and more particularly to a method of integrating a gas turbine with SAGD boilers along with CO₂ capture system such that a gas turbine is installed at a SAGD facility to generate most or all the facility's electrical requirements. The hot turbine exhaust, which contains 13-15% O₂, is then used as an oxidant stream in the SAGD boilers.

The method of the present invention is useful if CO₂ capture is implemented and the facility requires significant levels of power, which can be provided by the gas turbine. The benefits of this approach are the CO₂ produced in the gas turbine is removed along with CO₂ from the boilers, enabling a high overall avoidance, the electricity is generated at a very high efficiency. Thus, the Capital Expenditure (CAPEX) of the gas turbine is low relative to alternate power generation options.

In one aspect of the present invention, a system for increasing CO₂ avoidance is provided, which comprises: a gas turbine that has an air inlet, a fuel inlet and a turbine exhaust gas (TEG) outlet; a steam-assisted gravity drainage (SAGD) boiler that has a TEG inlet connected to the exhaust gas outlet of the gas turbine, a fuel inlet, and a flue gas outlet; and a carbon dioxide capture system that is connected to the flue gas outlet of the SAGD boiler.

In one embodiment, the SAGD boiler further comprises an air inlet, through which normal air can be optionally supplied to the SAGD boiler, primarily to increase the oxygen content as oxidant, especially in the cases where the exhaust gas from the gas turbine has too low oxygen content.

In some embodiments, a substantial amount of the carbon dioxide generated by the gas turbine and the SAGD boiler is captured by the CO₂ capture system. Preferably, more than 75% of the CO₂ generated by the gas turbine and the SAGD boiler is captured by the CO₂ capture system.

In another embodiment, the CO₂ capture system is a solvent-based flue gas scrubbing system in which the solvent absorbs CO₂ from the flue gas. The solvent is regenerated, releasing CO₂, which is further compressed for storage and/or transportation. Preferably, the solvent is an amine.

In another embodiment, the CO₂ capture system is a two-stage carbon capture system that first adsorbs carbon dioxide from the flue gas off the SAGD boiler, then the carbon dioxide is desorbed and can be cryogenically purified for further storage and/or transportation.

In some embodiments, the exhaust gas from the gas turbine has a temperature higher than 400° C. The sensible energy contained in the exhaust gas reduces the fuel required to generate a given quantity of steam in the boiler. However, the temperature of the exhaust gas can be adjusted before entering into the SAGD boiler, especially in the case where the high temperature may not be suitable for the ducting between the gas turbine and the SAGD boiler.

In another aspect of the present invention, a method for capturing carbon dioxide exhausted from a gas turbine and a steam assisted gravity drainage boiler is provided. The first step provides an integrated system comprising: the gas turbine having an air inlet, a fuel inlet, and a turbine exhaust gas (TEG) outlet, the SAGD boiler having a TEG inlet connected to the exhaust gas outlet of the gas turbine, an optional air inlet, a fuel inlet, and a flue gas outlet, and a carbon dioxide capture system connected to the flue gas outlet of the SAGD boiler. The gas turbine is then operated and exhaust gas is generated and transmitted to the SAGD boiler through the TEG inlet thereof. The SAGD boiler is then operated, and flue gas is generated and transmitted to the carbon dioxide capture system through the flue gas outlet of the SAGD boiler. The carbon dioxide capture system will then capture a substantial amount of carbon dioxide from the flue gas.

### BRIEF DESCRIPTION OF THE DRAWINGS

FIG. 1 is a schematic view showing the simplified flow diagram of integrated Gas Turbine SAGD Boiler process.

### DESCRIPTION OF EMBODIMENTS OF THE INVENTION

The present invention is exemplified with respect to a power plant using natural gas as the main source of fuel. However, this is exemplary only, and the invention can be broadly applied to generally all fossil-fuel burning power plants. The fuel used in the gas turbine would be restricted to only those fuels suitable for gas turbines, and can include various gaseous and liquid fuels. The fuel used in the boiler could include various gaseous, liquid, and solid fuels. The following examples are intended to be illustrative only, and not unduly limit the scope of the appended claims.

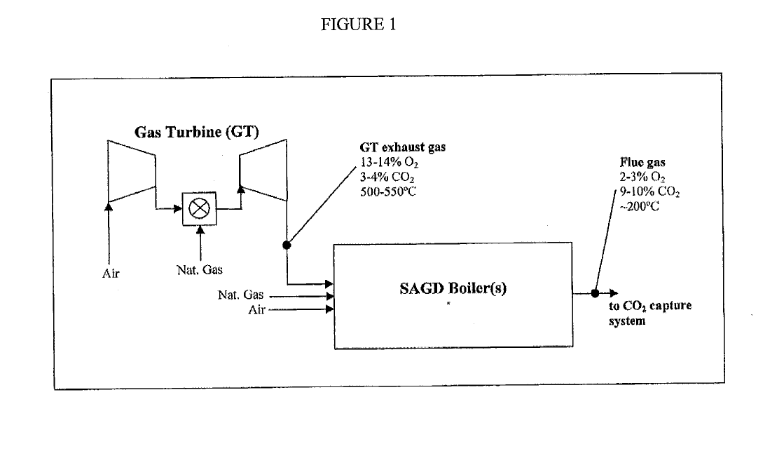

In one embodiment of the present invention, the simplified flow diagram of integrated gas turbine SAGD boiler process of the present invention is illustrated in FIG. 1. As shown in FIG. 1, a gas turbine is operated at a SAGD central processing facility to generate some or all of the site's power requirements. The exhaust from the gas turbine is delivered to SAGD boilers where it is used as an oxidant stream. This is made possible by the fact that gas turbines are operated at very high excess air levels and their exhaust streams typically contain 13-15 vol. % O₂ which is high enough to support combustion in many burners. Depending on the power requirements and flow rates, the boilers may also require some supplemental air to fully oxidize the fuel. The flue gas exiting the boilers will contain typical CO₂ and excess O₂ levels for gas-fired boilers (e.g. 2-4% O₂ and 8-10% CO₂). Preferably, the method of the present invention is used in an air-fired boiler, and not a DSG or oxy-fired boiler.

When implementing a carbon capture system, the stream will be delivered to a CO₂ capture system that may comprise an amine-based scrubbing system, a hybrid adsorption/cryogenic capture unit, or a hybrid membrane/cryogenic capture unit. The concept, however, does not lend itself to oxy-combustion systems because the gas turbine exhaust contains high levels of N₂ that will contaminate the otherwise CO₂-rich flue gas from oxy-boiler.

The present invention offers three major advantages.

First of all, the CO₂ production in the gas turbine is captured along with the CO₂ from the SAGD boilers. CO₂ capture from stand-alone gas turbines is difficult because of the low CO₂ levels in gas turbine exhaust as well as the high O₂ levels, which will have an adverse effect on amine-based systems.

Secondly, the electricity generated in the gas turbine is produced at very high marginal efficiencies. This is because the sensible heat in the turbine exhaust allows the firing rate of the SAGD boilers to be reduced, which offsets some of the fuel used in the turbine.

Thirdly, the CAPEX and footprint of a gas turbine, operated in simple cycle mode, is significantly lower than the CAPEX of alternate power generation options such as natural gas combined cycle (NGCC) plants. NGCC plants will require additional equipment such as a heat recovery steam generator (HRSG), steam turbines, condenser, cooling system, water treatment system, etc.

The following examples are illustrative only, and are not intended to unduly limit the scope of the invention.

### Example 1

### Integrated Gas Turbine-SAGD Boilers with and without Carbon Capture Systems

In this example, the invention is a process in which the flue gas from the integrated Gas Turbine-SAGD boiler system is delivered to a solvent-based carbon capture system that involves absorption of CO₂ from the flue gas into the solvent, followed by thermal regeneration of the solvent to release CO₂, which is further compressed. The solvent is thermally regenerated with heat from low-pressure steam generated in an auxiliary gas-fired boiler. The process modeling assumes that the MEA (monoethanolamine) solvent is used, and that a 90% CO₂ capture rate from flue gas is achieved. The flue gas from the SAGD boilers as well as the flue gas from the amine regenerator boilers is delivered to the capture system. This process is shown in FIG. 2.

Table 1 shows process modeling results for four cases. Case 1 represents SAGD boilers without CO₂ capture, using grid power. Case 2 represents the integrated GT-SAGD boilers, without CO₂ capture. Case 3 represents SAGD boilers with CO₂ capture, using grid power. Case 4 represents the integrated GT-SAGD boilers, with CO₂ capture.

In the analysis, the gas turbines were sized to produce sufficient power to cover close to or all the electrical load of facility, while the capture system captured 90% of the CO₂ in the SAGD boiler and amine regenerator flue gas. As shown in Table 1, the specific CO₂ emissions from the GT-SAGD Boiler system with capture (Case 4) is 7.1 kg/bbl bitumen, which represents a 90% reduction from a no capture SAGD boiler system with grid power (Case 1).

Table 1 also shows that the specific CO₂ emissions from a SAGD boiler system with CO₂ capture and with grid power (Case 3) would be 33.7 kg/bbl or a 53% reduction from the no-capture grid base case. In Case 3, most of the CO₂ emissions will be indirect (off-site) emissions associated with the power used by the facility. This shows that the GT-SAGD Boiler process, when coupled to a CO₂ capture system, can enable a substantially higher CO₂ emissions reduction if used in place of grid power.

TABLE 1
Key process results for SAGD Boilers with Amine-Based CO2
Capture Systems

| | Case 1 | | Case 3 | |
|---|---|---|---|---|
| | SAGD | Case 2 | SAGD | Case 4 |
| | Boilers | GT-SAGD | Boilers | GT-SAGD |
| | (no CO2 | Boilers (no | with CO2 | Boilers with |
| Parameter | capture) | capture) | Capture | CO2 Capture |
| Power source | Grid | Gas Turbines | Grid | Gas Turbines |
| Bitumen | 92,315 | 92,315 | 94,757 | 94,757 |
| production | | | | |
| rate (bpd) | | | | |
| SAGD steam | 1,526 | 1,526 | 1,567 | 1,567 |
| production | | | | |
| rate (tonne/hr)^{[1]} | | | | |
| SAGD boiler | 985 MWₜₕ | 857 MWₜₕ | 1,101 MWₜₕ | 945 MWₜₕ |
| firing rate | | | | |
| (LHV) | | | | |
| Gas turbine | — | 239 MWₜₕ | — | 358 MWₜₕ |
| firing rate | | | | |
| (LHV) | | | | |
| Amine | — | — | 105 MWₜₕ | 120 MWₜₕ |
| regenerator | | | | |
| boiler firing | | | | |
| rate (LHV)^{[2]} | | | | |
| Total gas | 985 MWₜₕ | 1,096 MWₜₕ | 1,206 MWₜₕ | 1,423 MWₜₕ |
| firing rate | | | | |
| (LHV) | | | | |
| Facility power | 92 MWₑ | 92 MWₑ | 124.2 MWₑ | 129.8 MWₑ |
| load | | | | |
| Gas Turbine | — | 86.6 MWₑ | — | 129.8 MWₑ |
| power | | | | |
| Grid power | 92 MWₑ | 5.4 MWₑ | 124.2 MWₑ | — |
| Total CO₂ | 195.3 | 217.2 | 239.1 | 282.0 |
| produced at | | | | |
| site (tonne/hr) | | | | |
| Total CO₂ | 195.3 | 217.2 | 23.9 | 28.2 |
| emitted at site | | | | |
| (tonne/hr) | | | | |
| Indirect CO₂ | 81.0 | 4.7 | 109.3 | — |
| emissions | | | | |
| from imported | | | | |
| grid power | | | | |
| (tonne/hr)^{[3]} | | | | |
| Total CO₂ | 276.3 | 221.9 | 133.2 | 28.2 |
| emissions | | | | |
| (tonne/hr) | | | | |
| Specific CO₂ | 71.8 | 57.7 | 33.7 | 7.1 |
| emissions | | | | |
| (kg/bbl | | | | |
| bitumen) | | | | |
| CO₂ emissions | — | 20% | 53% | 90% |
| reduction | | | | |
| (from base | | | | |
| case) | | | | |

^{[1]}Steam required for 92,315 or 94,750 bbl/day SAGD operations. Steam produced at steam oil ratio of 2.5 in once-through steam generators.
^{[2]}Based on estimated regeneration energy for MEA amine-based capture process
^{[3]}Assuming imported grid power, with CO₂ emissions of 0.88 kg/kWh

A comparison between Cases 1 and 2 illustrates the high power generation efficiency of the invention. As can be seen in the table, the GT-SAGD Boiler (no capture) case requires an additional 111 MWₜₕ (857+239−985=111) of natural gas. However, the additional 111 MWₜₕ of fuel required by the integrated process is effectively used to generate the 86.6 MWₑ power required by the facility. This power generation efficiency of 78% (LHV basis) is considerably higher than those of stand-alone power plants, which can generate power at efficiencies of at most 58% (LHV). Coupled with the relatively low CAPEX of the gas turbine, this represents a low-cost method of generating electricity at a SAGD facility.

An easy way to compare the carbon dioxide capturing capability is using the CO₂ avoidance formula, which is defined as:

Avoidance=[1−(CO₂ emitted_{capture case}/CO₂ emitted_{base case})]×100%

Taking Case 2 as the base case and Case 4 as the capture case, using specific emission,

Avoidance=[1−(7.1/57.7)]×100%=87%

By integrating the power generation system with the steam generation system and the carbon capture system, this invention enables a higher CO₂ avoidance with higher efficiency in generating power. Also, the cost of generating electricity via this method is lower than alternate on-site power generation options because of its very high efficiencies and low CAPEX.

The novelty of this approach is that the exhaust of a gas turbine is used as oxidant in SAGD boilers, and the CO₂ from the gas turbine is captured with CO₂ from the boilers if carbon capture is deployed. This enables low-cost on-site power generation due to the high efficiency and low CAPEX of the turbine, as well as higher CO₂ avoidances.

The following references are incorporated by reference in their entirety.
U.S. Pat. No. 6,200,128

What is claimed is:

1. An integrated system for increasing carbon dioxide avoidance, comprising:
a gas turbine having an air inlet, a fuel inlet and an exhaust gas outlet;
a steam-assisted gravity drainage (SAGD) boiler having an exhaust gas inlet connected to the exhaust gas outlet of the gas turbine, a fuel inlet, and a flue gas outlet; and
a carbon dioxide capture system connected to the flue gas outlet of the SAGD boiler.

2. The system of claim 1, wherein the SAGD boiler further comprising an air inlet, and normal air is supplied to the SAGD boiler through the air inlet.

3. The system of claim 1, wherein a substantial amount of the carbon dioxide generated from the gas turbine and the SAGD boiler is captured by the carbon dioxide capture system.

4. The system of claim 3, wherein the carbon dioxide avoidance of the system is greater than 75%, and the carbon dioxide avoidance is defined as:
Avoidance=[1−(CO₂ emitted_{capture case}/CO₂ emitted_{base case})]×100%

5. The system of claim 1, wherein the carbon dioxide capture system is a solvent-based system that scrubs CO₂ from the SAGD boiler flue gas

6. The system of claim 1, wherein the carbon dioxide capture system is a two-stage carbon capture system.

7. The system of claim 6, wherein the two-stage carbon capture system comprises (a) adsorption of carbon dioxide from the flue gas coming from the flue gas outlet of the SAGD boiler, and (b) cryogenic purification of the carbon dioxide desorbed from the previous stage.

8. The system of claim 1, wherein the exhaust gas in the exhaust gas outlet of the gas turbine has an oxygen concentration of more than 12% by volume.

9. The system of claim 1, wherein the exhaust gas in the exhaust gas outlet of the gas turbine has a temperature greater than 400° C.

10. A method for capturing carbon dioxide exhausted from a gas turbine and a steam assisted gravity drainage (SAGD) boiler, comprising:
a) providing an integrated system comprising the gas turbine having an air inlet, a fuel inlet, and an exhaust gas outlet, the SAGD boiler having an exhaust gas inlet connected to the exhaust gas outlet of the gas turbine, a fuel inlet, and a flue gas outlet, and a carbon dioxide capture system connected to the flue gas outlet of the SAGD boiler;
b) operating the gas turbine;
c) transmitting an exhaust gas from the gas turbine to the SAGD boiler through the exhaust gas inlet;
d) operating the SAGD boiler; and
e) capturing carbon dioxide by the carbon dioxide capture system from a flue gas exiting the flue gas outlet of the SAGD boiler.

11. The method of claim 10, wherein the SAGD boiler further comprising an air inlet, and normal air is supplied to the SAGD boiler through the air inlet.

12. The method of claim 10, wherein a substantial amount of the carbon dioxide generated from the gas turbine and the SAGD boiler is captured by the carbon dioxide capture system.

13. The method of claim 12, wherein the carbon dioxide avoidance of the system is greater than 75%, and the carbon dioxide avoidance is defined as:
Avoidance=[1−(CO₂ emitted_{capture case}/CO₂ emitted_{base case})]×100%

14. The method of claim 10, wherein the carbon dioxide capture system is a two-stage carbon capture system.

15. The method of claim 14, wherein the two-stage carbon capture system comprises (a) adsorption of carbon dioxide from the flue gas coming from the flue gas outlet of the SAGD boiler, and (b) cryogenic purification of the carbon dioxide desorbed from the previous stage.

16. The method of claim 10, where the carbon dioxide capture system is a solvent-based system that scrubs CO₂ from the SAGD boiler flue gas

17. The method of claim 10, wherein the exhaust gas in the exhaust gas outlet of the gas turbine has an oxygen concentration of more than 12% by volume.

18. The system of claim 10, wherein the exhaust gas in the exhaust gas outlet of the gas turbine has a temperature greater than 400° C.
